(19) United States
(12) Patent Application Publication
(10) Pub. No.: US 2010/0046035 A1
(43) Pub. Date: Feb. 25, 2010

(54) INFORMATION PROCESSING APPARATUS AND METHOD

(75) Inventor: Hideyuki Kinoshita, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/544,175

(22) Filed: Aug. 19, 2009

(30) Foreign Application Priority Data
Aug. 21, 2008 (JP) 2008-213293(PAT.)

(51) Int. Cl. H04N 1/405

(52) U.S. Cl. 358/3.06

(57) ABSTRACT

An information processing apparatus includes a first acquisition unit configured to acquire a frequency characteristic of a recording medium, a second acquisition unit configured to acquire a frequency characteristic of dot information, a dot density distribution calculation unit configured to calculate a dot density distribution based on the frequency characteristic of the recording medium and the frequency characteristic of the dot information, a correspondence generation unit configured to calculate a density of a binary image based on a density distribution of the binary image and the dot which corresponds to a halftone dot ratio and to generate a correspondence between the halftone dot ratio and the density, and a gradation correction generation unit configured to generate a gradation correction condition based on the correspondence between the halftone dot ratio and the density.

### BACKGROUND OF THE INVENTION

1. Field of the Invention

The present invention relates to a method for generating a gradation correction condition according to a type of a recording medium.

2. Description of the Related Art

A conventional image recording apparatus records an image on a recording medium by using a colorant such as an ink. When a final print product is output by such an image recording apparatus, characteristics of an input digital signal (input image signal), the image recording apparatus, and an image recording material affect image quality of the final print product.

Accordingly, one purpose of executing image processing by the image recording apparatus is to adjust an input image signal according to information acquired during generation of a digital image (input signal) and a characteristic of the input image signal itself.

In addition, another purpose of executing image processing by the image recording apparatus is to generate an output image signal by appropriately adjusting an input image signal according to characteristics of the image recording apparatus and a recording material.

Generation of the output image signal by adjusting the input image signal according to the characteristics of the image recording apparatus and the recording material, in other words, is the image processing such as color separation and image quantization. “Color separation” is to separate the input image signal into signals corresponding to output colors that the image recording apparatus can process according to a type of a recording medium and a condition for outputting the input image. “Quantization” is to binarize the input image. The condition for outputting an image includes a print mode, such as an image quality priority mode or a printing speed priority mode, which designates a print quality.

In recent years, a user has been setting a recording medium to be used and a print mode to the image recording apparatus as the output condition, and a color profile is selected according to the user setting. The image recording apparatus executes image processing, such as color reproduction processing, color separation processing, and gradation correction processing according to a color gamut thereof.

However, the user may desire to use a recording medium that does not conform to the image recording apparatus. Furthermore, the user may select a condition according to his or her own desire.

In this case, the condition selected by the user may not be always appropriate for the image recording apparatus and the recording medium. Accordingly, a technique is desired that would output an image by automatically selecting a condition for image processing, such as color reproduction, color separation, and gradation correction according to characteristics of an image recording apparatus and a recording medium.

If the image processing is automatically selected, a user who is not versed in image processing and a recording medium can easily operate an image recording apparatus. Further, if the image processing is automatically selected, it can be prevented that a user executes a wrong setting whose content is not actually desired by the user.

On the other hand, a number of types of recording media has increased every year. Accordingly, it is difficult for an image processing apparatus to previously store characteristics of all types of recording media in order to execute image processing according to the type of a recording medium. Therefore, it is useful to acquire a characteristic of a recording medium to be used at appropriate timing during image processing instead of previously storing characteristics of recording media.

U.S. Patent Application Publication No. 2005/0031392 discusses a technique for determining a type of a recording medium and selecting a print profile appropriate for the recording medium to execute print processing.

The technique discussed in U.S. Patent Application Publication No. 2005/0031392 uses a medium sensor capable of detecting a characteristic of a type of a recording medium. The type of the recording medium is determined according to information detected by the medium sensor and a print profile corresponding to the determined recording medium is selected. Accordingly, the image processing, such as color reproduction, color separation, and gradation correction dealing with the color gamut of the image recording apparatus can be executed.

An image recording apparatus, such as an inkjet printer, stores a gradation correction curve of each recording medium for each of the colors of cyan (C), magenta (M), and yellow (Y) to execute gradation correction among image processing, such as color reproduction, color separation, and gradation correction. Thus, the image recording apparatus executes conversion of image data based on each gradation correction curve.

U.S. Pat. No. 6,864,995 discusses a technique for calculating a gradation correction curve appropriate for a characteristic of an image output apparatus. In the technique discussed in U.S. Pat. No. 6,864,995, a color printer is used as an example of an image output apparatus that prints a gradation patch for each color as a test patch and calculates a gradation correction curve by color measuring of a density of the gradation patch.

Although the technique discussed in U.S. Patent Application Publication No. 2005/0031392 can achieve the intended effect, the following problems may arise.

When recording media of the same type (a gloss paper, for example) are used, if optical characteristics of the recording media, such as light absorption characteristics or levels of light scattered on surfaces of the recording media, differ from each other, then levels of density distribution of the recording material, which is applied on the recording media, may differ. Accordingly, images may be recorded at different density levels.

In this case, if the recording materials are applied in the same manner on recording media of different optical characteristics, then the same density may not be reproduced on the recording media.

Further, if gradation correction is executed according to a result of measurement of a test patch output on a recording medium as discussed in U.S. Pat. No. 6,864,995, the recording material and recording medium used in outputting the test patch require higher cost.

Particularly because the number of types of recording media has recently increased as described above, if a test patch is output and measured to determine gradation correction curves every time a different recording medium is used, costs for the repeated outputting and measurement may become very high.

### SUMMARY OF THE INVENTION

The present invention is directed to a technique for executing appropriate image processing according to a type of a recording medium.

According to an aspect of the present invention, an information processing apparatus includes a first acquisition unit configured to acquire a frequency characteristic of a recording medium, a second acquisition unit configured to acquire a frequency characteristic of dot information, a dot density distribution calculation unit configured to calculate a dot density distribution based on the frequency characteristic of the recording medium and the frequency characteristic of the dot information, a correspondence generation unit configured to calculate a density of a binary image based on a density distribution of the binary image and the dot which corresponds to a halftone dot ratio and to generate a correspondence between the halftone dot ratio and the density, and a gradation correction generation unit configured to generate a gradation correction condition based on the correspondence between the halftone dot ratio and the density.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 is a block diagram illustrating an example of a configuration of an image processing apparatus according to a first exemplary embodiment of the present invention.

FIG. 2 is a block diagram illustrating an example of a configuration of a frequency characteristic measurement unit.

FIG. 3 illustrates an example pattern of a slit of a slit plate.

FIGS. 4A and 4B illustrate examples of average images in the horizontal direction and the vertical direction, respectively.

FIGS. 5A and 5B each illustrates an example of a frequency characteristic.

FIG. 6 is a block diagram illustrating an example of a configuration of a dot density distribution calculation unit.

FIGS. 7A and 7B each illustrates a distribution of a density of a reference dot.

FIGS. 8A and 8B each illustrates a distribution of a density of a dot acquired by a dot density distribution calculation unit.

FIG. 9 is a block diagram illustrating an example of a configuration of a gradation correction calculation unit.

FIG. 10 is a flow chart illustrating an example of processing executed by the gradation correction calculation unit.

FIG. 11 illustrates an example of a binary image when a halftone dot ratio is 8%.

FIG. 12 illustrates a density distribution acquired from the binary image illustrated in FIG. 11.

FIG. 13 illustrates an example of contents stored on a memory.

FIGS. 14A and 14B each illustrates a relationship between a halftone dot ratio and an image density.

FIG. 15 illustrates an example of a gradation correction value p.

FIGS. 16A and 16B each illustrate a method for setting a gradation correction curve.

FIG. 17 illustrates an example of use of a gradation correction curve.

FIG. 18 is a block diagram illustrating an example of a configuration of an image processing apparatus according to a second exemplary embodiment of the present invention.

FIG. 19 illustrates a relationship between a recording medium type and dot information.

FIG. 20 illustrates an example of the dot information illustrated in FIG. 19.

FIG. 21 is a block diagram illustrating an example of a configuration of an image processing apparatus according to a third exemplary embodiment of the present invention.

FIG. 22 is a block diagram illustrating an example of a configuration of a dot information calculation unit.

FIG. 23 illustrates an example of a binary image.

FIGS. 24A and 24B each illustrates an example of dot information which is useful if stored for the example illustrated in FIG. 23.

FIGS. 25A, 25B, and 25C each illustrates an example of a 2×2 binary image.

FIGS. 26A, 26B, and 26C each illustrates an example of dot information which is useful if stored for each of example illustrated in FIG. 25.

FIG. 27 is a block diagram illustrating another example of a configuration of a frequency characteristic measurement unit.

FIG. 28 illustrates an example of a recording pattern.

### DETAILED DESCRIPTION OF THE EMBODIMENTS

Various exemplary embodiments, features, and aspects of the present invention will now be herein described in detail below with reference to the drawings.

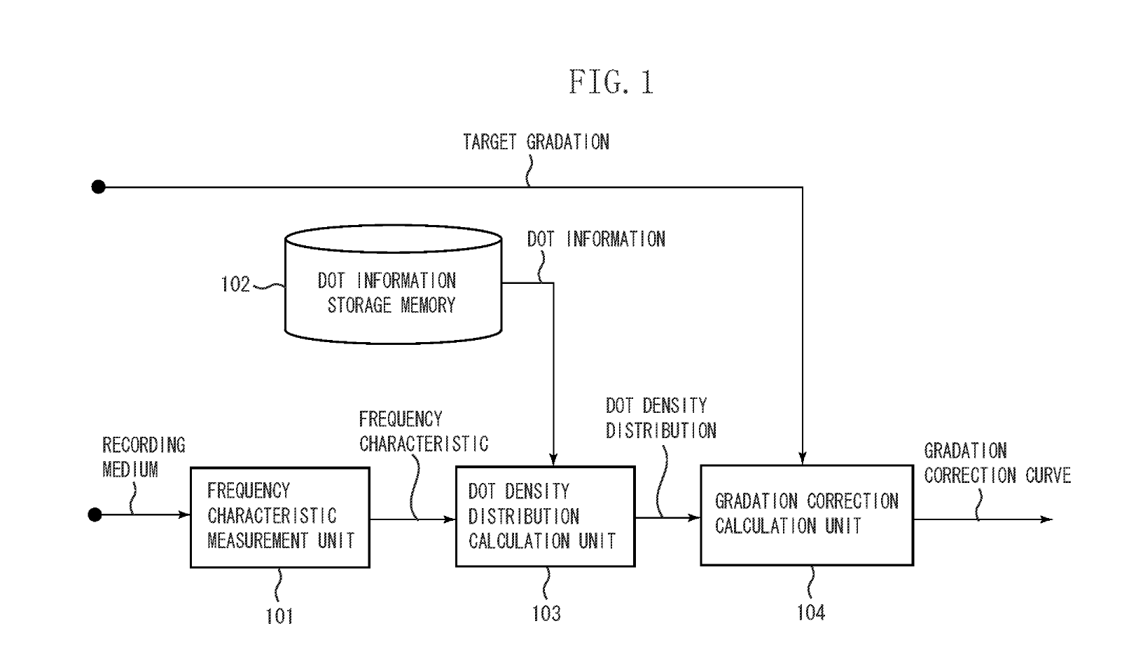

A first exemplary embodiment of the present invention will be described below. FIG. 1 is a block diagram illustrating a configuration of an image processing apparatus according to the first exemplary embodiment.

The image processing apparatus includes a frequency characteristic measurement unit 101 configured to measure a frequency characteristic of a recording medium and a dot information storage memory 102 configured to previously store dot information. The dot information is an example of a gradation correction information generation condition.

In addition, the image processing apparatus includes a dot density distribution calculation unit 103. The dot density distribution calculation unit 103 calculates a dot density distribution on the recording medium according to two input values including the dot information and the frequency characteristic of the recording medium measures by the frequency characteristic measurement unit 101.

Furthermore, the image processing apparatus includes a gradation correction calculation unit 104. The gradation correction calculation unit 104 sets gradation correction information for achieving a target gradation by using the dot density distribution calculated by the dot density distribution calculation unit 103. A “dot” is formed on the recording medium by using a recording material, such as an ink used by an inkjet printer. The dot information will be described in detail below. The gradation correction information is, for example, information about a gradation correction curve.

The dot density distribution calculation unit 103 and the gradation correction calculation unit 104 each function as a gradation correction information generation unit.

Each component of the image processing apparatus according to the present exemplary embodiment will be described in detail below.

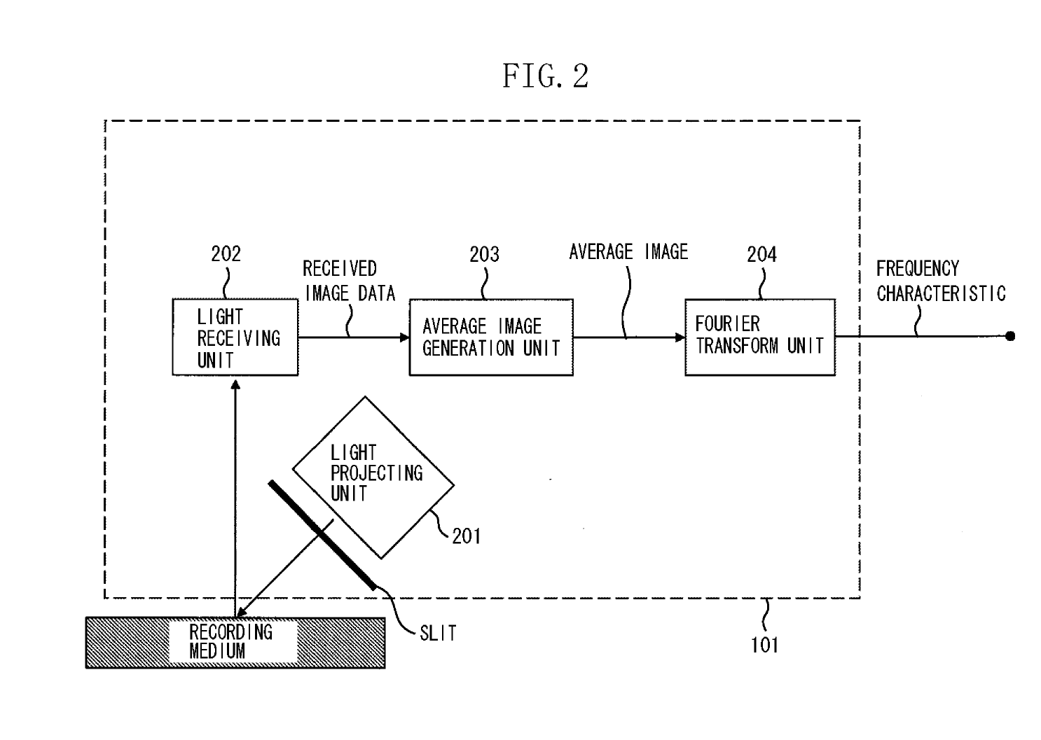

FIG. 2 is a block diagram illustrating a configuration of the frequency characteristic measurement unit 101. The frequency characteristic measurement unit 101 includes a light projecting unit 201, a light receiving unit 202, an average image generation unit 203, and a Fourier transform unit 204.

The light projecting unit 201 irradiates a recording medium with light by using a light source (a halogen lamp, for example). The light irradiated on the recording medium forms a predetermined pattern by transmitting through a slit plate which is provided in front of the light source.

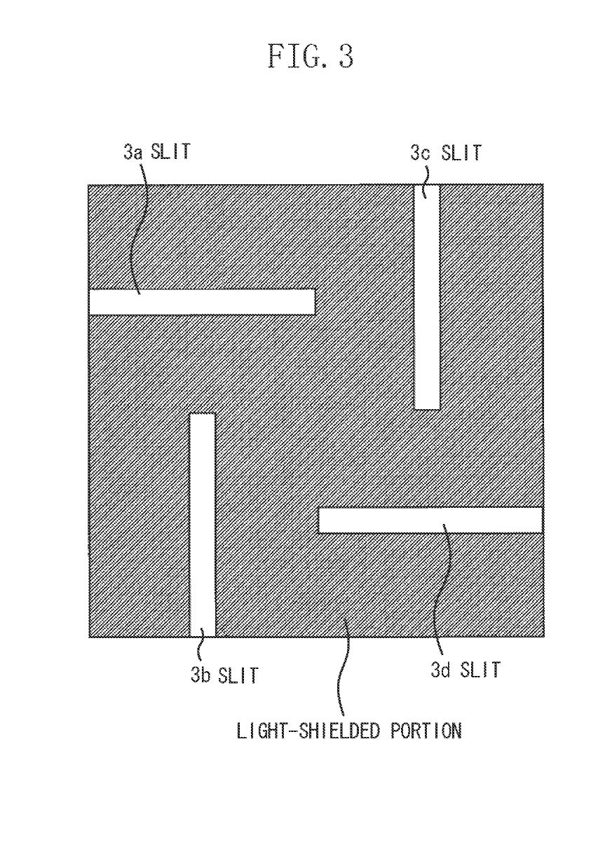

FIG. 3 illustrates an example of a pattern of the slit of the slit plate according to the present exemplary embodiment. On the slit plate, rectangular slits 3a and 3d whose longer side is oriented in the horizontal direction in FIG. 3, and rectangular slits 3b and 3c whose longer side is oriented in the vertical direction in FIG. 3 are diagonally provided.

The light receiving unit 202 includes a light-sensitive element (e.g., a charge-coupled device (CCD) image sensor) which receives light reflected from the recording medium. The light receiving unit 202 acquires a reflection image by receiving the light reflected from the recording medium.

In the present exemplary embodiment, an incident angle of the light projected from the light projecting unit 201 onto the recording medium is 45°. The light receiving unit 202 receives the reflection light in the direction of a line normal to the recording medium. Optical geometric conditions for the light projecting unit 201, the recording medium, and the light receiving unit 202 can be arbitrarily set in the present exemplary embodiment.

The average image generation unit 203 generates an average image based on data of the reflection image (acquired image data) acquired by the light receiving unit 202.

In order to simplify image processing, in the present exemplary embodiment, two average images including an average image of image data in the horizontal orientation and another average image of image data in the vertical direction are formed. By using the average image, the present exemplary embodiment can cancel variation of measurement values which may occur due to noise in measurement and a difference of measured portions of the recording medium.

It is also useful if an average image in other directions, for example, a direction at an angle of 45° from the horizontal direction of image data, is generated and used.

The present exemplary embodiment generates an average image in the horizontal direction by extracting a portion of a pattern formed on the recording medium via the slits 3a and 3d (FIG. 3) from the acquired image. Similarly, an average image in the vertical direction is generated by extracting a portion of a pattern formed on the recording medium via the slits 3b and 3c (FIG. 3) from the acquired image.

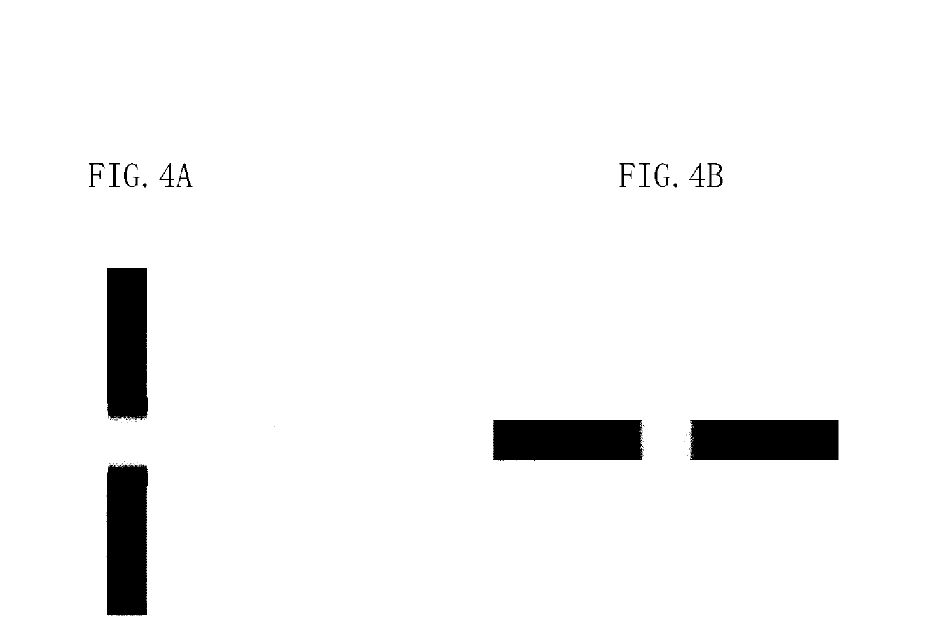

FIG. 4A illustrates an example of an average image in the horizontal direction. FIG. 4B illustrates an example of an average image in the vertical direction.

An image of a pattern light on the recording medium may be blurred due to the frequency characteristic of the recording medium. Accordingly, the acquired image may be blurred from the center of the image towards both shorter-side ends thereof.

The Fourier transform unit 204 executes one-dimensional high-speed Fourier transform on the average image to calculate the frequency characteristic in each of the horizontal and vertical directions of the recording medium. In the present exemplary embodiment, a modulation transfer function (MTF) value (a spatial frequency characteristic value) which is a value of an amplitude at each frequency is used as the frequency characteristic.

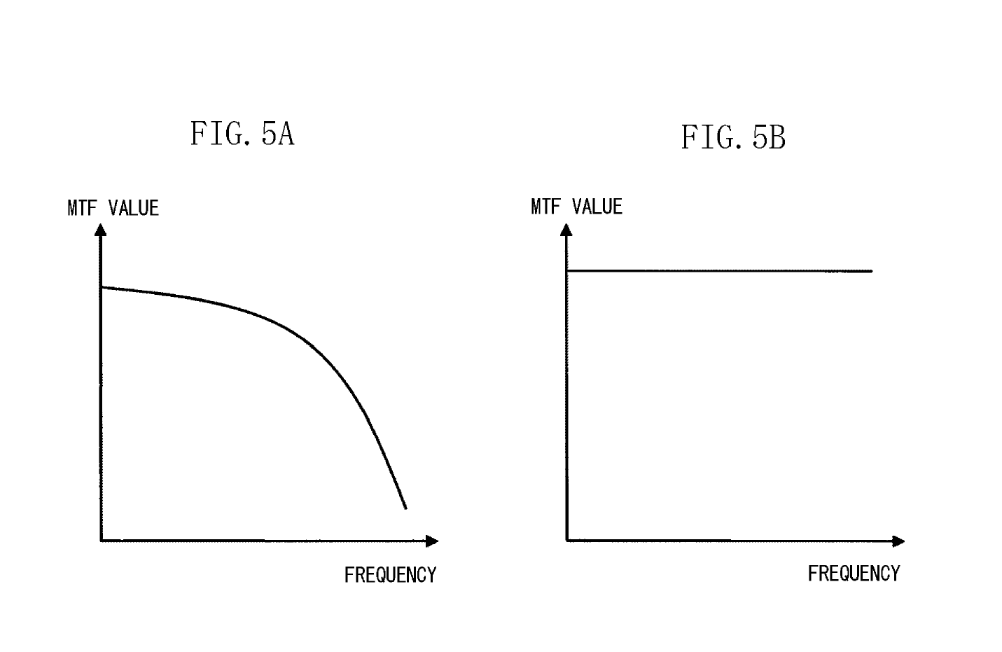

FIG. 5A illustrates an example of the frequency characteristic. In the graph illustrated in FIG. 5A, the frequency is taken on the horizontal axis while an MTF value at each frequency is taken on the vertical axis.

At an ideal frequency characteristic at which no light irradiated onto the recording medium is blurred the MTF value is always “1” regardless of the frequency. FIG. 5B illustrates the ideal frequency characteristic.

However, in an actual case, the light reflected on the recording medium may be blurred because the light is absorbed and is scattered by irregular surface of the recording medium. Therefore, an actual frequency characteristic is as illustrated in FIG. 5A. More specifically, reproducibility of a high-frequency component is particularly likely to become low.

In measuring the frequency characteristic of the recording medium, it is not necessary to calculate an average frequency characteristic based on results of the measurement of one portion of the recording medium. More specifically, the average frequency characteristic may be calculated based on results of measurement of a plurality of portions of the recording medium which can be acquired by moving the recording medium during the measurement.

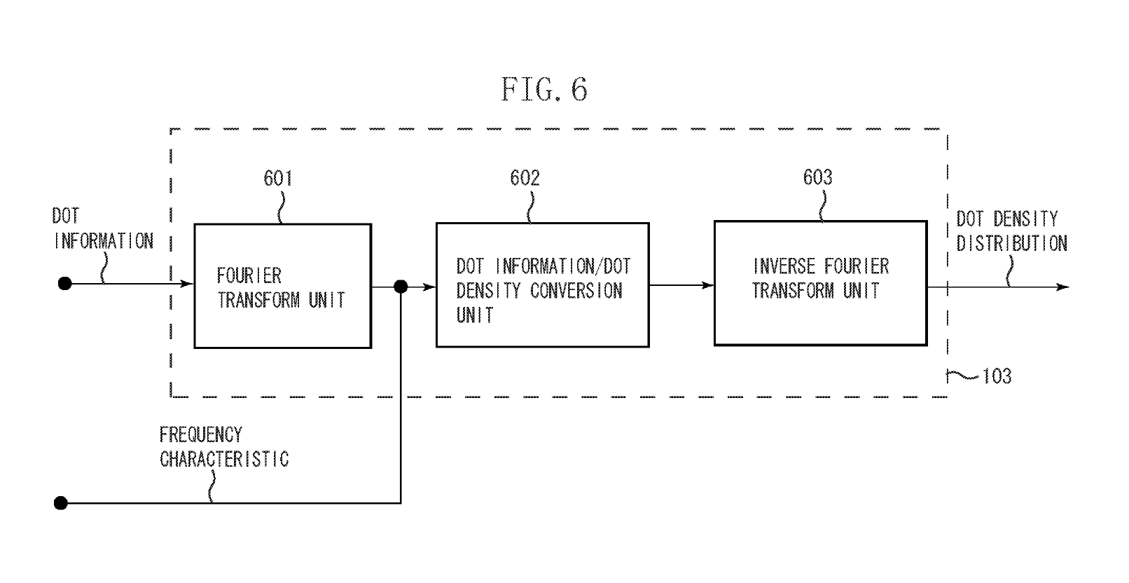

FIG. 6 is a block diagram illustrating a configuration of the dot density distribution calculation unit 103 according to the present exemplary embodiment.

The dot density distribution calculation unit 103 includes a Fourier transform unit 601, a dot information/dot density conversion unit 602, and an inverse Fourier transform unit 603.

Dot information which has been stored on the dot information storage memory 102 is input to the Fourier transform unit 601. The dot information refers to information indicating the density distribution of dots when an ink is applied on the recording medium having the ideal frequency characteristic illustrated in FIG. 5B. In other words, the dot information refers to the density distribution of dots that is not affected by the frequency characteristic of the recording medium. Hereinbelow, the above-described dot information will be referred to as a “reference dot density”.

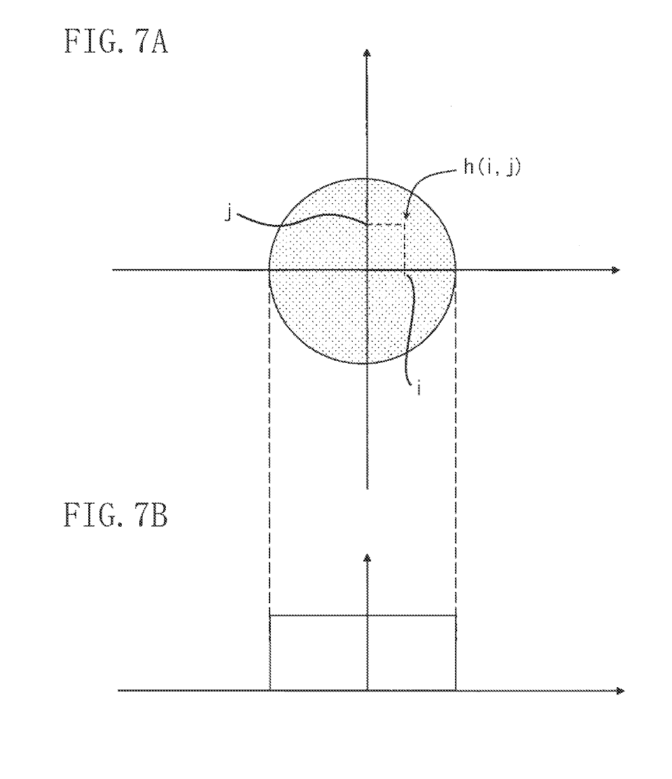

FIG. 7A illustrates an example of a reference dot density distribution. FIG. 7B illustrates an example of a reference dot density on a one-dimensional cross section through the center of a dot.

The Fourier transform unit 601 executes two-dimensional high-speed Fourier transform on the dot information which is the density information in the real space to convert the same into a numerical value D₀(u,v) on a frequency space. The conversion by the Fourier transform unit 601 can be expressed by the following expression (1):

D₀(u,v)=FFT(d₀(i,j)) (1).

The two-dimensional directions for executing the Fourier transform are the same as the directions for executing the one-dimensional high-speed Fourier transform by the Fourier transform unit 204. More specifically, in the present exemplary embodiment, the two-dimensional Fourier transform is executed in the horizontal and the vertical directions of the recording medium.

The dot information/dot density conversion unit 602 calculates information indicating the dot density distribution according to dot information D (u,v) on the two-dimensional frequency space acquired by the Fourier transform unit 601 and the frequency characteristic in two directions of the recording medium acquired by the frequency characteristic measurement unit 101.

A two-dimensional frequency characteristic MTF (u,v) of the recording medium can be calculated by the following expression (2):

MTF(u,v)=f(u)×θ/90+f(v)×(90−θ)/90 (2)

where “f(u)” and “f(v)” respectively denote a frequency characteristic of the recording medium in the horizontal direction and the vertical direction which are acquired by the frequency characteristic measurement unit 101, and “θ” denotes an angle of a line passing through a point (u,v) and an origin point against a u-axis.

The dot information/dot density conversion unit 602 executes the conversion expressed by the following expression (3) by using the dot information and the frequency characteristic of the recording medium both of which are numerical values on the two-dimensional frequency space:

D(u,v)=D₀(u,v)·MTF(u,v) (3).

The inverse Fourier transform unit 603 executes two-dimensional inverse Fourier transform expressed by the following expression (4) on the dot density distribution information D (u,v) in the two-dimensional frequency space acquired by the dot information/dot density conversion unit 602 to acquire a numerical value d (i,j) in the real space:

d(i,j)=FFT⁻¹(D(u,v)) (4).

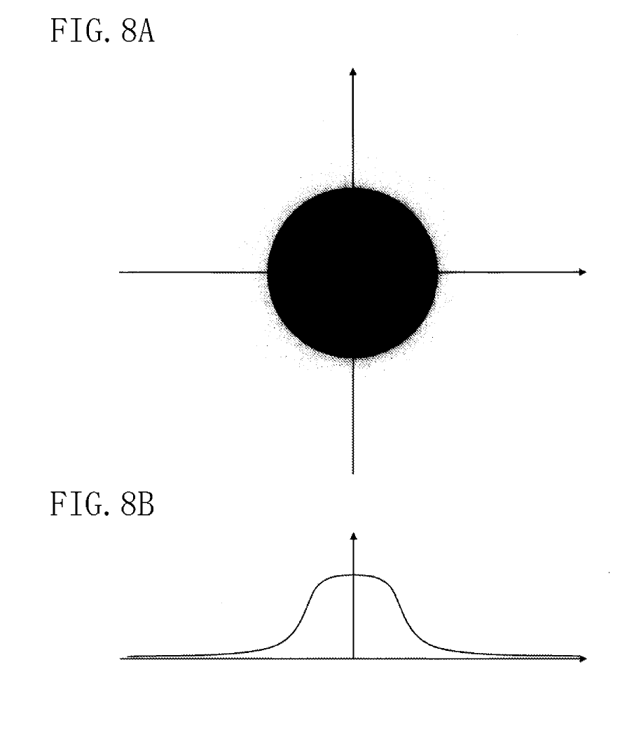

FIG. 8A illustrates an example of the dot density distribution acquired by the dot density distribution calculation unit 103. FIG. 8B illustrates an example of the dot density distribution on the one-dimensional cross section through the center of the dot.

FIG. 8A illustrates a state of a dot which has been recorded on the recording medium observed from a viewpoint vertically above the recording surface of the recording medium. As illustrated in FIG. 8A, a phenomenon of blur of the edge of the recorded dot which may occur due to the frequency characteristic of the recording medium can be reproduced.

As described above, the optical geometric conditions for the light projecting unit 201, the recording medium, and the light receiving unit 202 can be arbitrarily set. Meanwhile, the frequency characteristic of the recording medium which is calculated by the dot density distribution calculation unit 103 may vary according to the optical geometric conditions. Therefore, it is desirable to always set the same optical geometric conditions if the same conditions for the calculation by the dot density distribution calculation unit 103 are used.

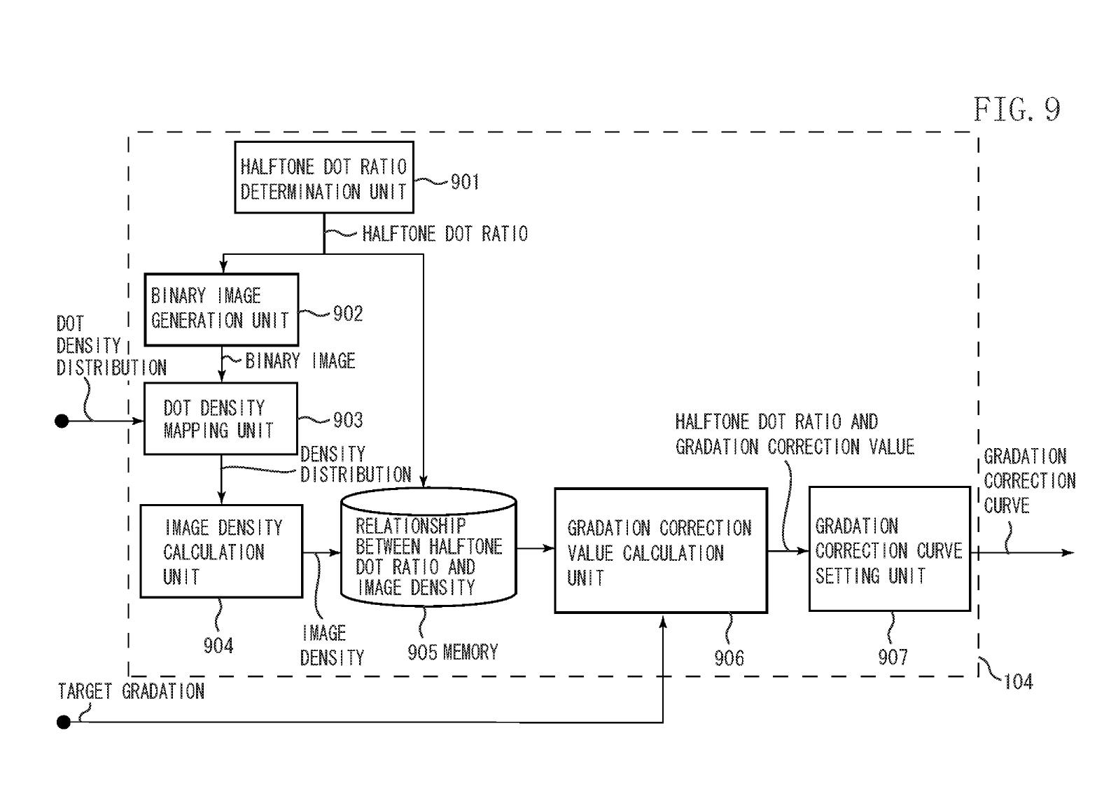

FIG. 9 is a block diagram illustrating a configuration of the gradation correction calculation unit 104 according to the present exemplary embodiment.

The gradation correction calculation unit 104 includes a halftone dot ratio determination unit 901, a binary image generation unit 902, a dot density mapping unit 903, an image density calculation unit 904, a memory 905, a gradation correction value calculation unit 906, and a gradation correction curve setting unit 907.

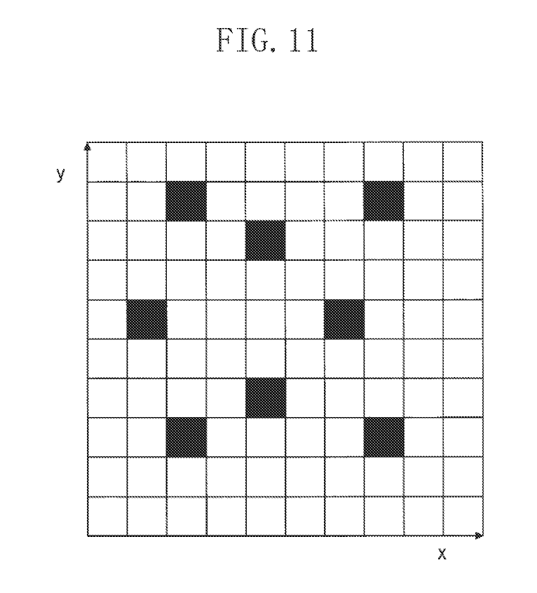

The binary image generation unit 902 generates a binary image according to a halftone dot ratio set by the halftone dot ratio determination unit 901. If the halftone dot ratio is set at 8%, then the binary image generation unit 902 generates a binary image illustrated in FIG. 11.

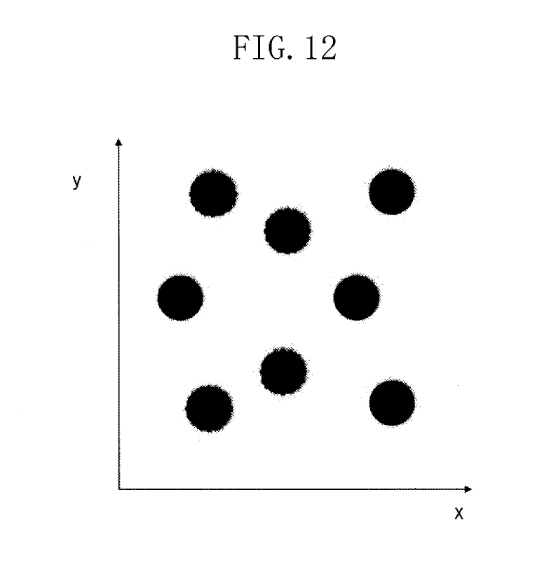

The dot density mapping unit 903 generates a density distribution of an image formed by recording dots on the recording medium based on the binary image generated by the binary image generation unit 902 and the dot density calculated by the dot density distribution calculation unit 103. More specifically, when the binary image illustrated in FIG. 11 is input, the dot density mapping unit 903 generates the density distribution illustrated in FIG. 12 by assigning the dot density in the center of black blocks indicated in FIG. 11.

The image density calculation unit 904 calculates an average density of the image according to the density distribution of the image generated by the dot density mapping unit 903. More specifically, an average density of an image D_{avg} can be calculated by the following expression (5):

D_{avg}=(ΣΣD(x,y))/(W×H) (5)

where “D(x,y)” denotes a density at coordinates (x,y) within the image illustrated in FIG. 12 and “W×H” denotes the size of the image.

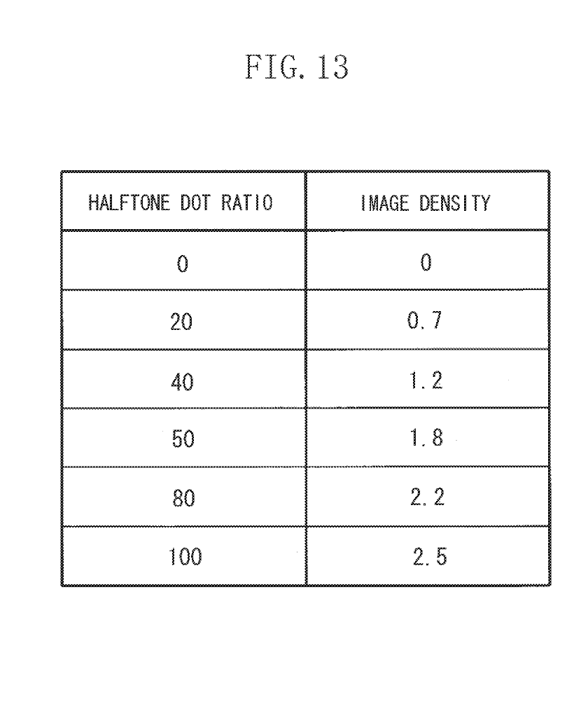

The memory 905 stores a relationship between the halftone dot ratio determined by the halftone dot ratio determination unit 901 and the average density of the image calculated by the image density calculation unit 904 as a relationship between the halftone dot ratio and an area density. The contents stored on the memory 905 can be presented by a table indicating a correspondence between the halftone dot ratio and the image density as illustrated in FIG. 13.

The gradation correction value calculation unit 906 calculates a gradation correction value according to the relationship between the halftone dot ratio and the image density stored on the memory 905.

A target gradation can be calculated by an expression “Y=X^{γ}” where “X” denotes the halftone dot ratio and “Y” denotes the image density. In this case, the gradation correction value can be calculated in the following manner. The target gradation can be arbitrarily set.

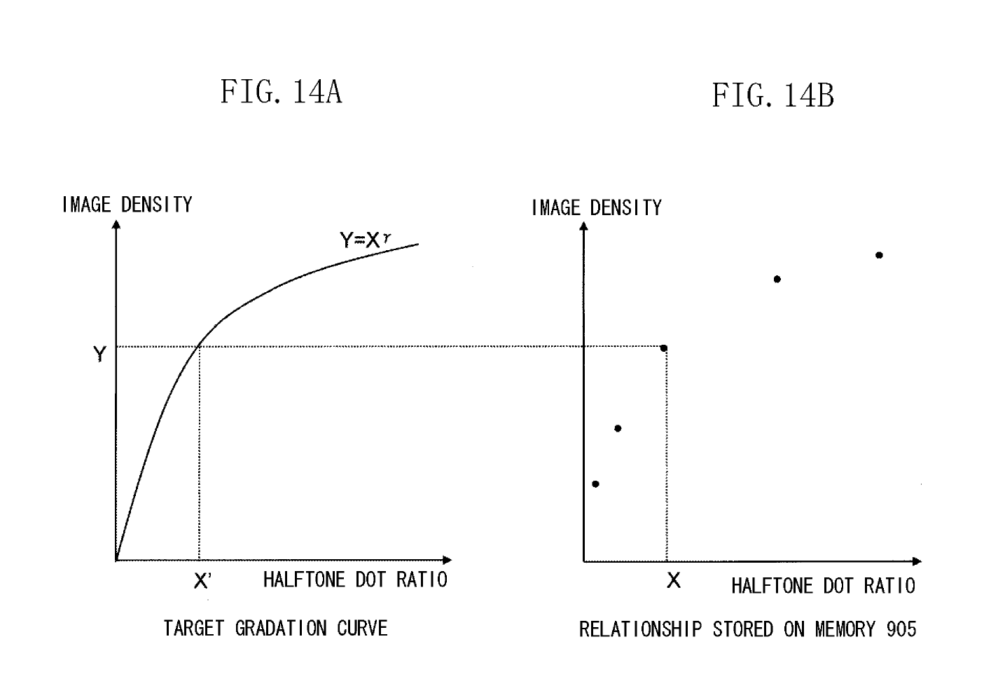

The target gradation which can be calculated by the expression “Y=X^{γ}” and the relationship between the halftone dot ratio and the image density stored on the memory 905 can be respectively presented by graphs illustrated in FIGS. 14A and 14B.

Referring to FIG. 14B, the halftone dot ratio by which the image density Y can be achieved is “X”. However, in order to achieve the target gradation Y=X^{γ}, it is necessary to achieve the image density Y when the halftone dot ratio is “X′”. In this case, it becomes necessary to correct the halftone dot ratio “X′” to the halftone dot ratio “X”. A correction coefficient is used as the gradation correction value.

More specifically, a value of a term “p” in the following expression (6) which expresses the relationship between the halftone dot ratios “X′” and “X” is the gradation correction value:

X=p×X′ (6).

Furthermore, the halftone dot ratio “X′” and the image density Y are in a relationship expressed by the following expression (7), and therefore, the gradation correction value p can be expressed by the following expression (8):

X′=Y^{1/γ} (7)

p=X/Y^{1/γ} (8).

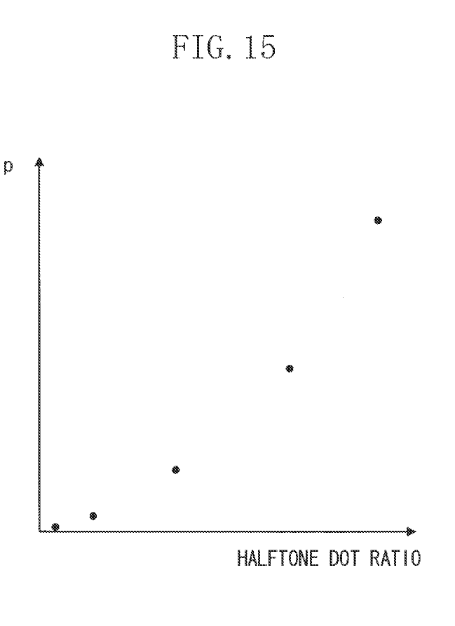

The gradation correction value p which is calculated by the gradation correction value calculation unit 906 is as illustrated in FIG. 15.

The gradation correction curve setting unit 907 sets a gradation correction curve according to the gradation correction value p which is calculated by the gradation correction value calculation unit 906.

The gradation correction curve can be set in the following manners when the relationship between the halftone dot ratio and the gradation correction value p (FIG. 15) is calculated by the gradation correction value calculation unit 906.

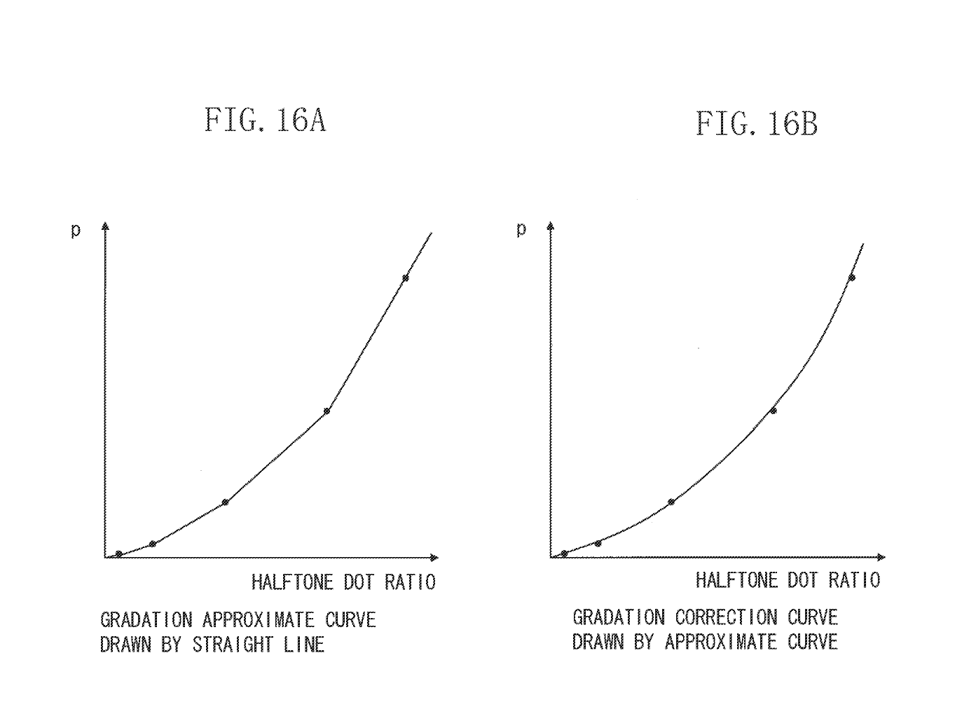

The gradation correction curve can be set by a method for generating a gradation correction curve as continuous straight lines including straight lines connecting two mutually adjacent points of the halftone dot ratio as illustrated in FIG. 16A. In addition, the gradation correction curve can be set by another method for generating a gradation correction curve on a smooth curve asymptotic to all points of the halftone dot ratio as illustrated in FIG. 16B. However, the present exemplary embodiment can use a method other than the above-described methods.

The information about the gradation correction curve set by the gradation correction curve setting unit 907 is expressed by either of an expression for a curve or a lookup table storing the correspondence between the halftone dot ratio and the gradation correction value.

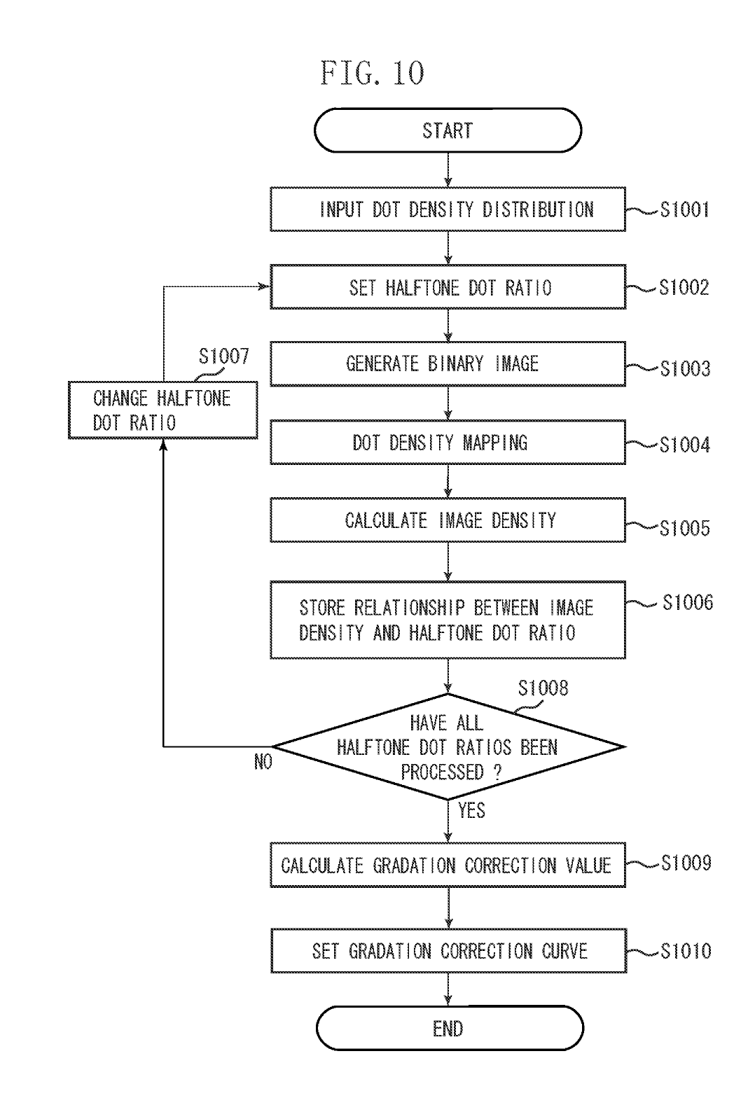

An operation of the gradation correction calculation unit 104 having the above-described configuration will be described in detail below. FIG. 10 is a flow chart illustrating an example of processing executed by the gradation correction calculation unit 104.

Referring to FIG. 10, in step S1001, a dot density distribution calculated by the dot density distribution calculation unit 103 is input. In step S1002, the halftone dot ratio determination unit 901 sets the halftone dot ratio.

In step S1003, the binary image generation unit 902 generates a binary image according to the halftone dot ratio that has been set by the halftone dot ratio determination unit 901.

In step S1004, the dot density mapping unit 903 generates a density distribution of the image based on the binary image generated by the binary image generation unit 902 and the dot density calculated by the dot density distribution calculation unit 103.

In step S1005, the image density calculation unit 904 calculates an average density of the image based on the density distribution generated by the dot density mapping unit 903.

In step S1006, the memory 905 stores the relationship between the halftone dot ratio determined by the halftone dot ratio determination unit 901 and the image density calculated by the image density calculation unit 904.

In step S1007, the halftone dot ratio determination unit 901 changes the halftone dot ratio. In step S1008, the processing in steps S1002 through S1006 is repeatedly executed for all the halftone dot ratios determined by the halftone dot ratio determination unit 901.

When the processing in steps S1002 through S1006 is completed for all the halftone dot ratios determined by the halftone dot ratio determination unit 901 as described above, the processing advances to step S1009. In step S1009, the gradation correction value calculation unit 906 calculates the gradation correction value p based on the relationship between the halftone dot ratio and the image density stored on the memory 905.

In step S1010, the gradation correction curve setting unit 907 which functions as a gradation correction information setting unit sets the gradation correction curve based on the gradation correction value p that has been calculated by the gradation correction value calculation unit 906.

In the above-described manner, the gradation correction calculation unit 104 calculates and generates a gradation correction curve which can be used as one of the image processing conditions.

In the image processing apparatus having the above-described configuration, in order to generate a gradation correction curve, a recording medium on which no image has been formed is used as a measurement target recording medium. The frequency characteristic measurement unit 101 measures the frequency characteristic of the recording medium. A gradation correction curve is generated by executing processing by the dot density distribution calculation unit 103 and the gradation correction calculation unit 104.

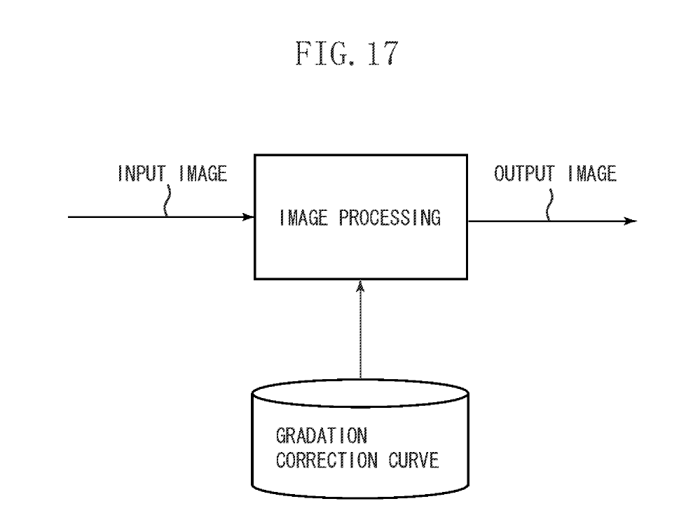

The gradation correction curve generated in the above-described manner is used in the image processing on an input image as illustrated in FIG. 17. Thus, the present exemplary embodiment can execute gradation correction appropriate for the recording medium. In measuring the frequency characteristic of the recording medium, a portion of the measurement target recording medium in which no image is recorded can be used. As described above, the present exemplary embodiment measures a frequency characteristic of a recording medium based on a degree of sharpness of a pattern light on the recording medium.

Thus, the first exemplary embodiment can generate a dot density corresponding to a recording medium by measuring the frequency characteristic of the recording medium and execute the gradation correction appropriate for the recording medium by using the generated dot density.

A second exemplary embodiment of the present invention will be described in detail below. In the above-described first exemplary embodiment, dot information when the dot is recorded on a recording medium is previously stored and used in correcting gradation. On the other hand, the second exemplary embodiment previously stores a type of a recording medium and dot information corresponding to each recording medium and selects the dot information used in correcting gradation according to the type of the recording medium.

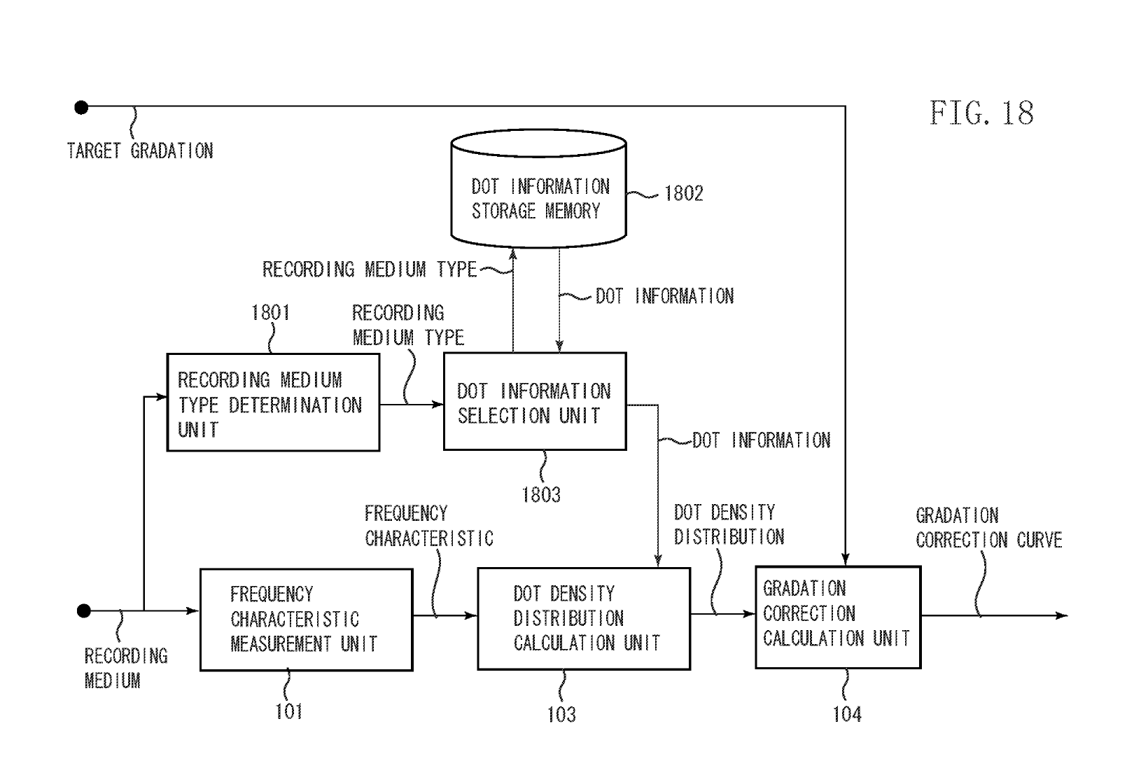

FIG. 18 is a block diagram illustrating a configuration of an image processing apparatus according to the second exemplary embodiment.

Referring to FIG. 18, the image processing apparatus includes a recording medium type determination unit 1801 and a dot information selection unit 1803. In addition, the image processing apparatus includes a dot information storage memory 1802 instead of the dot information storage memory 102. Other configurations are the same as those in the first exemplary embodiment of the present invention.

The recording medium type determination unit 1801 determines the type of a recording medium by using a medium sensor (not illustrated). A medium sensor discussed in U.S. patent publication No. 2005/0031392 can be used as the recording medium type determination unit 1801. The recording medium type determination unit 1801 may use information set by a user via a user interface to execute the above-described determination. The recording medium type can include a plain paper, a gloss paper, and a mat paper.

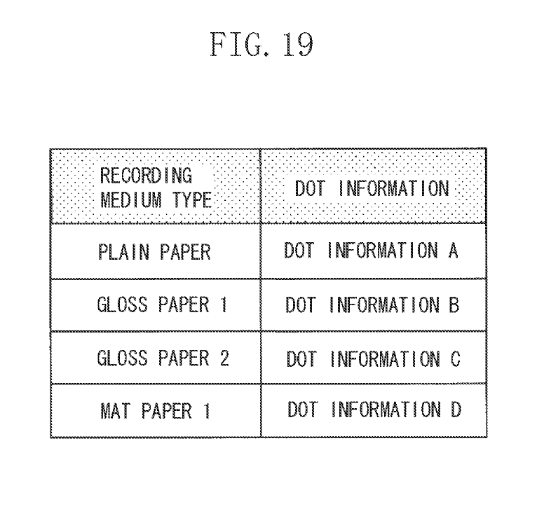

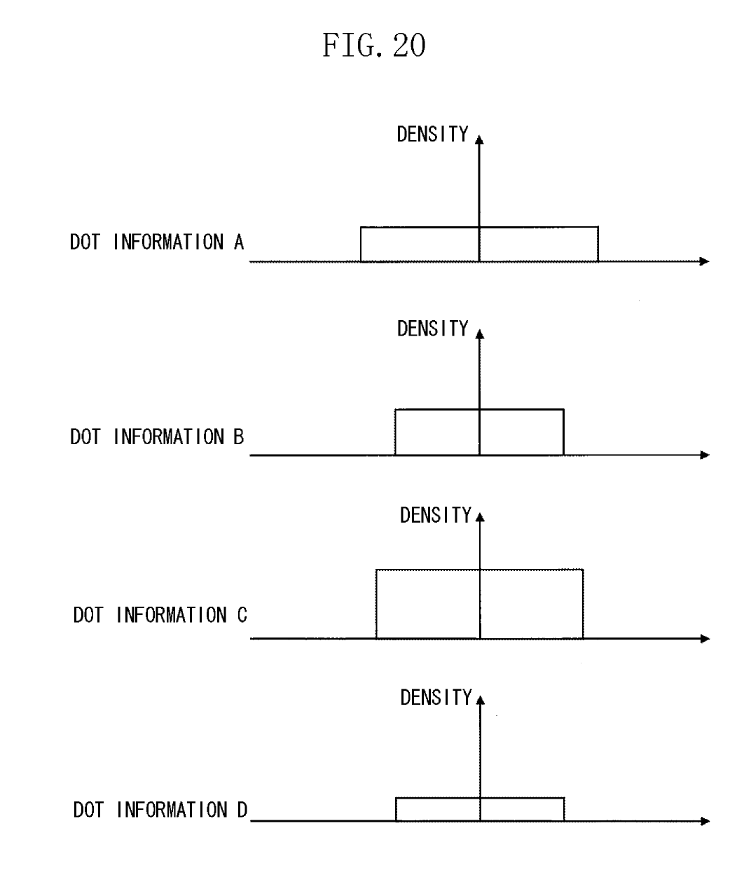

The dot information storage memory 1802 stores information about a correspondence between the recording medium type and the dot information as illustrated in FIG. 19. The dot information illustrated in FIG. 19 can include information about dots of different diameters (magnitudes) and densities as illustrated in FIG. 20.

The dot information selection unit 1803 refers to the dot information storage memory 1802 and selects the dot information corresponding to the input recording medium type.

In the above-described manner, in the second exemplary embodiment, the dot density distribution calculation unit 103 acquires the dot information selected by the dot information selection unit 1803 according to the recording medium type. In addition, the dot density distribution calculation unit 103 calculates the dot density distribution based on the dot information and the frequency characteristic acquired by the frequency characteristic measurement unit 101 as described above.

Accordingly, the second exemplary embodiment can correct gradation by using the dot information acquired when dots are actually recorded on each recording medium.

A third exemplary embodiment of the present invention will be described in detail below. In the above-described first and the second exemplary embodiments, in order to correct gradation, a dot density when the dot is recorded on a recording medium is calculated based on the previously stored dot information and the frequency characteristic of the recording medium acquired by the above-described measurement processing. In the third exemplary embodiment, dot information is acquired by measuring a density of a recorded dot.

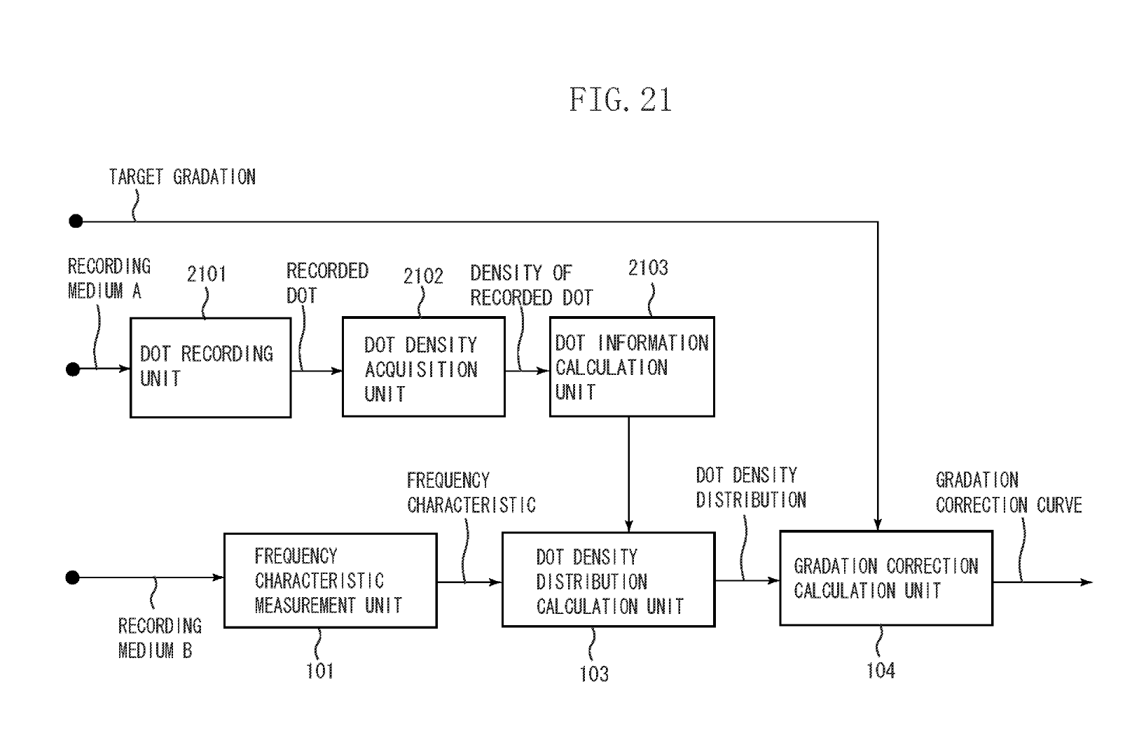

FIG. 21 is a block diagram illustrating a configuration of an image processing apparatus according to the third exemplary embodiment.

Referring to FIG. 21, the image processing apparatus includes a dot recording unit 2101, a dot density acquisition unit 2102, and a dot information calculation unit 2103. In the present exemplary embodiment, the image processing apparatus does not include the dot information storage memory 102 which is included in the image processing apparatus in the first exemplary embodiment. Other configurations are the same as those in the first exemplary embodiment of the present invention.

In the present exemplary embodiment, the dot recording unit 2101 functions as a gradation correction information generation condition generation unit and the dot information calculation unit 2103 functions as a gradation correction information generation condition changing unit.

The dot recording unit 2101 records a dot on a recording medium “A”. An inkjet printer which is an example of an image output apparatus is used for the dot recording unit 2101. In this case, the dot recording unit 2101 records one dot on the recording medium “A”, for example.

The dot density acquisition unit 2102 acquires a reflection image of the dot recorded by the dot recording unit 2101 by using a light-sensitive element (e.g., a CCD image sensor). The dot density acquisition unit 2102 calculates the recorded dot density based on a relationship between a pixel value of the reflection image and the density of the reflection image. The recorded dot density is related to a characteristic of an ink (recording material).

The dot information calculation unit 2103 calculates dot information based on the recorded dot density acquired by the dot density acquisition unit 2102.

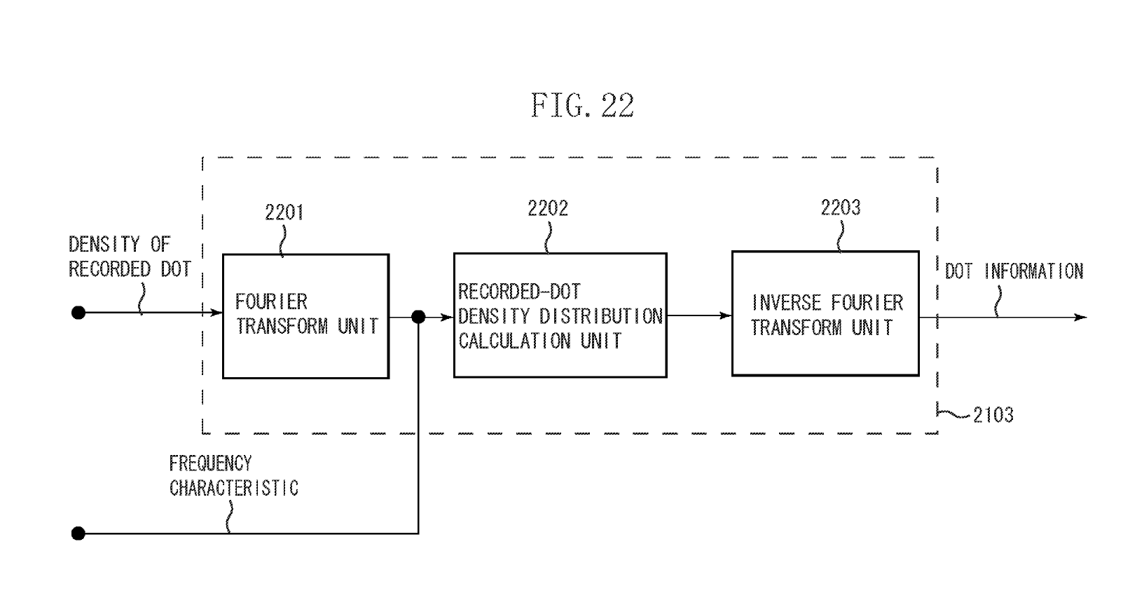

FIG. 22 is a block diagram illustrating a configuration of the dot information calculation unit 2103.

The dot information calculation unit 2103 includes a Fourier transform unit 2201, a recorded dot density distribution calculation unit 2202, and an inverse Fourier transform unit 2203.

The Fourier transform unit 2201 executes the Fourier transform expressed by the following expression (9):

D₁(u,v)=FFT(d₁(i,j)) (9)

where “d₁(i,j)” denotes a recorded dot density acquired by the dot density acquisition unit 2102.

The recorded dot density distribution calculation unit 2202 executes the calculation expressed by the following expression (10) on a value of a term “D₁(u,v)” which has been calculated by the Fourier transform unit 2201 to cancel an effect from a frequency characteristic of the recording medium “A” (MTF_{A}):

D(u,v)=D₁(u,v)/MTF_{A}(u,v) (10).

The inverse Fourier transform unit 2203 executes inverse Fourier transform expressed by the following expression (11) on a value of a term D(u,v) which has been calculated by the recorded dot density distribution calculation unit 2202 to calculate dot information which is not affected by the frequency characteristic of the recording medium “A”:

d(i,j)=FFT⁻¹(D(u,v)) (11).

The dot information can be acquired by executing the processing by the dot recording unit 2101, the dot density acquisition unit 2102, and the dot information calculation unit 2103 described above.

As described above, in the third exemplary embodiment, the dot density distribution calculation unit 103 can acquire the dot information calculated by the dot information calculation unit 2103. Further, the dot density distribution calculation unit 103 calculates the dot density distribution based on the dot information and the frequency characteristic of a recording medium “B” on which a dot is to be actually recorded acquired by the frequency characteristic measurement unit 101.

Therefore, the present exemplary embodiment can generate a gradation correction curve by using the dot information when the dot is actually recorded on a recording medium. In the present exemplary embodiment, the type of the recording medium “A” can be different from or the same as the type of the recording medium “B”.

In order to correct gradation, each of the above-described first through the third exemplary embodiments uses the density distribution of one dot. However, when dots are actually recorded, a plurality of dots may be recorded adjacent to one another or in a mutually overlapping manner.

Accordingly, if the density distribution of one dot only is used, the gradation correction value may not be calculated with a high accuracy.

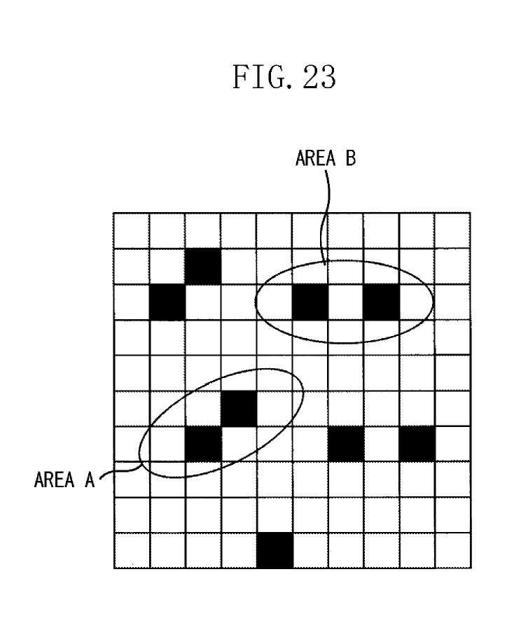

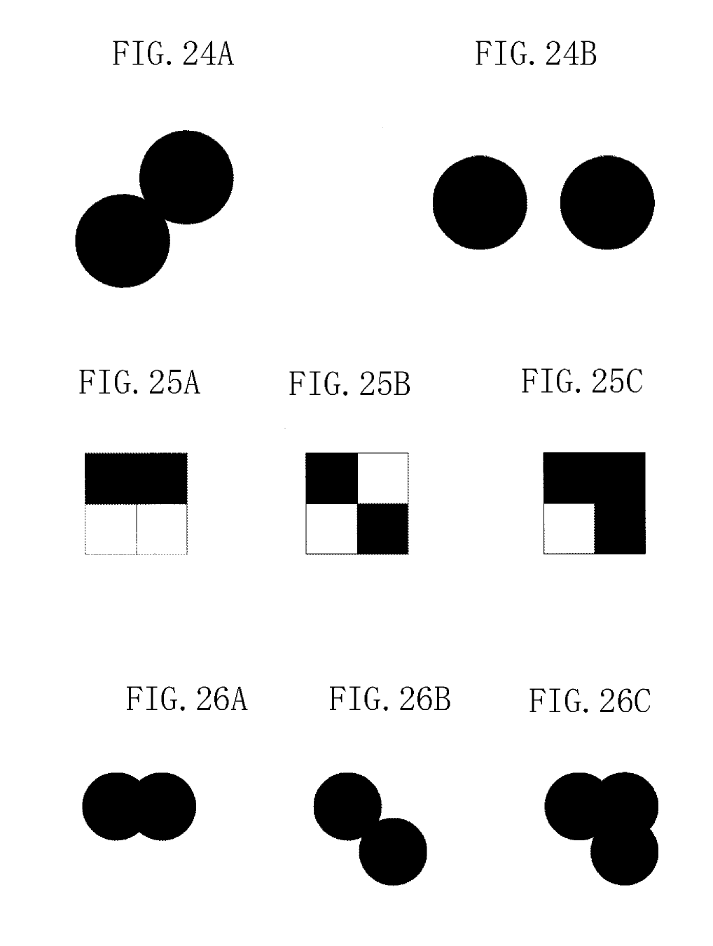

For example, in a binary image illustrated in FIG. 23 which is generated by the binary image generation unit 902, a plurality of dots may be overlapped with each another in an area “A” or recorded adjacent to each other in an area “B”, for example. Accordingly, it is useful to store dot information about overlapping dots (FIG. 24A) and adjacent dots (FIG. 24B) on the premise that a binary image described above may be generated by the binary image generation unit 902.

Moreover, dot information may be stored by previously assuming a binary pattern which may appear in a binary image. More specifically, a binary pattern illustrated in each of FIGS. 25A through 25C can be assumed to appear in a 2×2 binary image. Accordingly, it is useful to store dot information illustrated in each of FIGS. 26A through 26C for each binary pattern.

The dot information used in the first and the second exemplary embodiments and the dot density measured in the third exemplary embodiment can be acquired from dots illustrated in FIGS. 24A and 24B or FIGS. 26A through 26C. Thus, it is not necessary to use dot information of one dot only.

By storing dot information of a plurality of dots, the present exemplary embodiment can reproduce an arrangement of dots actually recorded on a recording medium and calculate the gradation correction value with a high accuracy.

Another example of the frequency characteristic measurement unit 101 will be described in detail below. In the above-described embodiments, the frequency characteristic of a recording medium is measured based on a pattern of light irradiated onto the recording medium. In the present exemplary embodiment, the frequency characteristic of a recording medium is measured by using a pattern recorded on the recording medium.

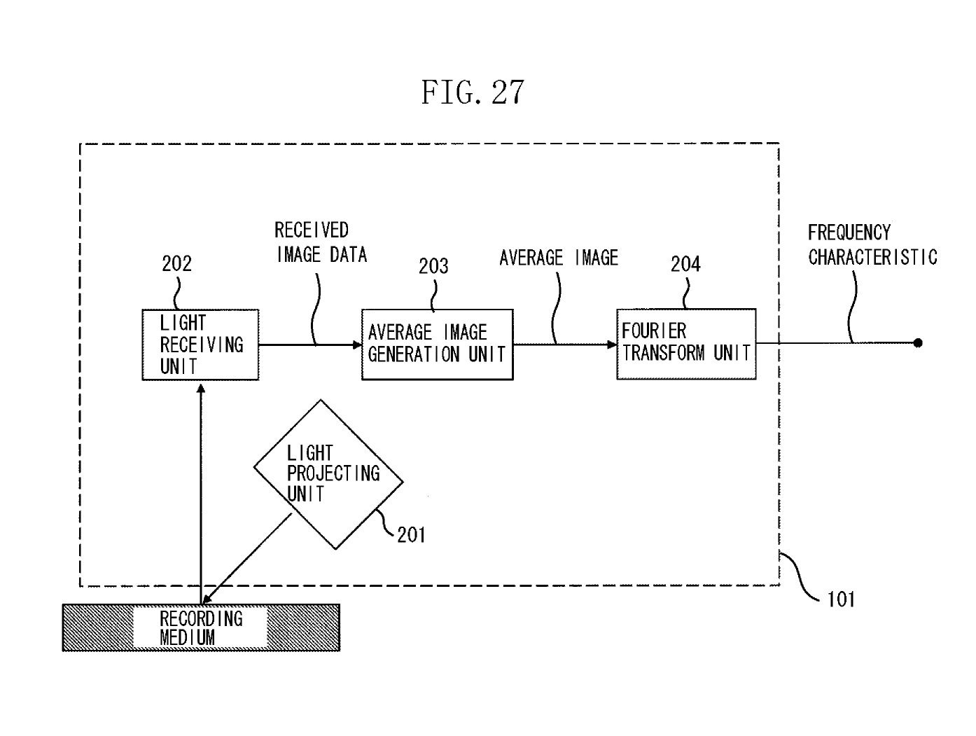

FIG. 27 is a block diagram illustrating another example of a configuration of the frequency characteristic measurement unit 101.

In the present exemplary embodiment, the frequency characteristic measurement unit 101 does not include a slit plate. Accordingly, the light projected from the light projecting unit 201 is evenly irradiated onto the recording medium. Other configurations are the same as those in the first through the third exemplary embodiments of the present invention.

If an image processing apparatus including the frequency characteristic measurement unit 101 having the above-described configuration is used, a colorant is applied on a recording medium by using an image forming apparatus and an arbitrary pattern is previously recorded. In this case, a dedicated colorant and a pattern to be recorded are previously determined and used in measuring the frequency characteristic.

In forming a pattern on a recording medium, an image forming apparatus that finally records an image or a different other image forming apparatus may be used.

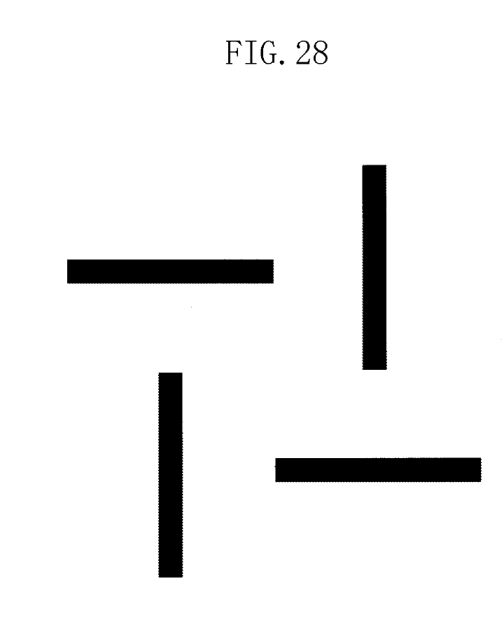

FIG. 28 illustrates an example of a pattern to be recorded. The light receiving unit 202 captures an image of a recorded pattern in FIG. 28. The frequency characteristic of the recording medium is measured based on a degree of sharpness of the pattern recorded on the recording medium.

The image processing apparatus including the frequency characteristic measurement unit 101 having the above-described configuration measures the frequency characteristic according to the pattern recorded on the recording medium as described above. Accordingly, the present exemplary embodiment can measure the frequency characteristic under the same conditions as those at the time of actual recording.

In the above-described embodiments of the present invention, the gradation is corrected based on the dot density distribution. However, the gradation correction can be executed by using a reflectance of a dot instead of using the dot density. In addition, a dot density or a dot reflectance of a spectrum and luminosity of a dot can be used in correcting gradation. Accordingly, the present exemplary embodiment can correct gradation if a colorant is used.

Alternatively, a user can arbitrarily designate a target gradation which is an index value used in correcting gradation via a user interface (UI).

The above described problems regarding gradation correction may arise if an image forming apparatus such as an electrophotographic type or a sublimation type printer is used. In addition, the above-described exemplary embodiments the present invention can solve the above-described problem. Accordingly, the present invention can be applied to an electrophotographic type printer and a sublimation type printer as well as an inkjet printer.

Each exemplary embodiment of the present invention can be implemented by executing a program corresponding to the configuration of each exemplary embodiment with a central processing unit (CPU) of a computer.

Furthermore, a medium for supplying a program to the computer, such as a computer-readable recording medium (e.g., a compact disc-read only memory (CD-ROM)) storing the above-described program and a transmission medium that transmits the above-described program, such as the Internet, can be included in the scope of the present invention as an exemplary embodiment of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-213293 filed Aug. 21, 2008, which is hereby incorporated by reference herein in its entirety.

What is claimed is:

1. An information processing apparatus comprising:
a first acquisition unit configured to acquire a frequency characteristic of a recording medium;
a second acquisition unit configured to acquire a frequency characteristic of dot information;
a dot density distribution calculation unit configured to calculate a dot density distribution based on the frequency characteristic of the recording medium and the frequency characteristic of the dot information;
a correspondence generation unit configured to calculate a density of a binary image based on a density distribution of the binary image and the dot which corresponds to a halftone dot ratio and to generate a correspondence between the halftone dot ratio and the density; and
a gradation correction generation unit configured to generate a gradation correction condition based on the correspondence between the halftone dot ratio and the density.

2. The information processing apparatus according to claim 1, wherein the frequency characteristic of the recording medium and the frequency characteristic of the dot include frequency characteristics in horizontal and vertical directions respectively.

3. The information processing apparatus according to claim 1, wherein the dot information indicates the density distribution of a dot that is not affected by the frequency characteristic of the recording medium.

4. The information processing apparatus according to claim 1, wherein the first acquisition unit calculates the frequency characteristic of the recording medium by measuring reflection light of two-dimensional pattern light with which the recording medium is irradiated and by executing Fourier transform on a result of the measurement.

5. The information processing apparatus according to claim 1, wherein the frequency characteristic of the dot information is calculated based on information about a shape of the dot according to a type of the recording medium.

6. The information processing apparatus according to claim 1, wherein the frequency characteristic of the dot information is calculated by acquiring density distribution of a dot recorded on a different recording medium and dividing the frequency characteristic of the acquired density distribution of the dot by a frequency characteristic of the different recording medium.

7. A method for processing information, the method comprising:
acquiring a frequency characteristic of a recording medium;
acquiring a frequency characteristic of dot information;
calculating a dot density distribution based on the frequency characteristic of the recording medium and the frequency characteristic of the dot information;
calculating a density of a binary image based on a density distribution of the binary image and the dot which corresponds to a halftone dot ratio and generating a correspondence between the halftone dot ratio and the density; and
generating a gradation correction condition based on the correspondence between the halftone dot ratio and the density.

8. A computer-readable recording medium storing instructions which cause a computer to execute operations described in the method according to claim 7.
